(19) United States
(12) Patent Application Publication
(10) Pub. No.: US 2007/0291008 A1
(43) Pub. Date: Dec. 20, 2007

(54) Inverted direct touch sensitive input devices

(76) Inventors: Daniel Wigdor, Toronto (CA); Darren Leigh, Somerville, MA (US); Clifton Forlines, Brookline, MA (US); Chia Shen, Lexington, MA (US); John C. Barnwell, Leominster, MA (US); Samuel E. Shipman, Acton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/455,150

(22) Filed: Jun. 16, 2006

(51) Int. Cl. G06F 3/041

(52) U.S. Cl. 345/173

(57) ABSTRACT

A direct touch-sensitive input device includes a display surface configured to display images on a front of the display surface, and a direct touch-sensitive surface mounted on a back of the display surface. The display surface and the direct touch-sensitive surface are geometrically coincident. The device can also include a touch-sensitive surface mounted on the front of the device.

### FIELD OF THE INVENTION

This invention relates generally to input devices for computer systems, and more particular to touch-sensitive input devices.

### BACKGROUND OF THE INVENTION

There are basically two types of touch sensitive input devices: indirect touch and direct touch. An example of an indirect touch input device is a touch pad on a laptop computer. There, the touch surface does not coincide with the display surface or screen. Typically, the touch sensitive surface is arranged in a horizontal plane, and the display surface is substantially vertical. In addition, the aspect rations, i.e., horizontal and vertical sizes, of most indirect input devices are different than the aspect rations of the display surfaces. This lack of coincidence makes these types of devices indirect touch input devices. As an advantage, touching the surface does not occlude the display surface from the user.

There are basically two types of direct touch sensitive surfaces. Back projected and front projected. The typical back projected touch sensitive surface is transparent and mounted on the front of a display screen, such as CRT or LCD display. A typical front projected touch sensitive surface is usually embedded in the display surface, such as a tabletop or wallboard, and images are projected onto the touch sensitive surface. In either case, the touch sensitive surface geometrically coincides with the display surface. That is, locations on the touch sensitive surface have a one-to-one correspondence with positions on the display surface. This geometric coincidence makes these types of devices direct touch input devices. As a disadvantage, touching the surface always occludes at least part of the display surface from the user's view.

As used herein, “front” means on a side of the display surface facing the user(s), and “back” means the opposite side of the display surface facing away from the user(s). For a tabletop direct touch device, the front and back correspond to “top” and “bottom”.

A multi-user, multi-touch direct input system is described by Dietz et al., “DiamondTouch: a multi-user touch technology,” In Proceedings of the 14th Annual ACM Symposium on User interface Software and Technology, ACM/UIST '01, pp. 219-226, 2001 and U.S. Pat. No. 6,498,590, both incorporated herein by reference. The DiamondTouch system has a unique property that other touch technologies do not have. The system can uniquely identify multiple users with multiple touches.

FIG. 1 schematically shows the prior art DiamondTouch, multi-user, touch-sensitive display system. The system includes a table 110 with a display surface 120, a touch sensitive surface 130 embedded in the front of the display surface, one or more chairs 140, a projector 150, and a processor 160. The chairs are conductive, or include a conductive pad in the seat. When users sit in one of the chairs 140 and touch the surface 130, a capacitive coupling is induced between the users and the surface. This coupling can be detected and analyzed by the processor. As a unique feature, multiple touches or gestures can be detected concurrently for a single user or multiple users because the chairs are individually coupled to the touch sensitive surface via the users.

During operation, images are displayed on the front surface 120 by the projector 150. The processor coordinates the displayed images according to the touching.

Whether single touch, or multi-touch, and where the input means (the display surface), and the output means (the touch sensitive surface) coincide on the front of the device, one obvious problem is that the touching 170 occludes the displayed images from the user.

To overcome this problem some systems project images at an angle, Matsushita et al., “Lumisight table: a face-to-face collaboration support system that optimizes direction of projected information to each stakeholder,” In Proceedings of the 2004 ACM Conference on Computer Supported Cooperative Work, ACM/CSCW '04., pp. 274-283, 2004. However, it is not possible to prevent all occlusions because the direct touching of the display surface necessitates the placement of the hand between the user's eyes and the surface.

It is desired, to provide a touch-sensitive display surface, where the touching does not occlude displayed images.

### SUMMARY OF THE INVENTION

The embodiments of the invention provide system and method for using direct touch-sensitive input device. The system has a touch-sensitive surface mounted on the back of a display surface. That along or in combination with a second front mounted touch-sensitive surface solves some disadvantages of direct touch-sensitive input device, like occluding displayed images from the user during user interaction. The embodiments of the invention demonstrate examples of utilizing invention in computer devices like touchtable, laptop, telephone and handheld computer device. The method shows touching strategies while using back and/or front mounted display surface.

### BRIEF DESCRIPTION OF THE DRAWINGS

FIG. 1 is a side view of a prior art touch-sensitive display surface;

FIG. 2 is a side view of a touch-sensitive display surface according to an embodiment of the invention;

FIG. 3A is a side view of a two-sided touch sensitive display surface according to an embodiment of the invention mounted horizontally according to an embodiment of the invention;

FIG. 3B is a top view of a two-sided touch sensitive display surface mounted vertically according to an embodiment of the invention;

FIG. 3C is a side view of a two-sided touch sensitive display surface of a laptop computer according to an embodiment of the invention;

FIG. 3D is a side view of a two-sided touch sensitive display surface of handheld computer according to an embodiment of the invention;

FIG. 3E is a side view of a two-sided touch sensitive display surface of a mobile telephone according to an embodiment of the invention;

FIG. 4 is a schematic of a touching of a back of the surface of FIG. 2;

FIG. 5A is a schematic of a touching a display of a pointer on a front mounted touch-sensitive surface;

FIG. 5B is a schematic of a touching a display of a pointer on a back mounted touch-sensitive surface;

FIG. 6 is a schematic of inverted hands touching;

FIG. 7 is a schematic of various hand symmetries;

FIG. 8 is a schematic of a single user two-handed symmetry;

FIG. 9 is a schematic of a two user two-handed symmetry;

FIG. 10 is a schematic of two-handed symmetries; and

FIG. 11 is a schematic of two display surfaces according to an embodiment of the invention.

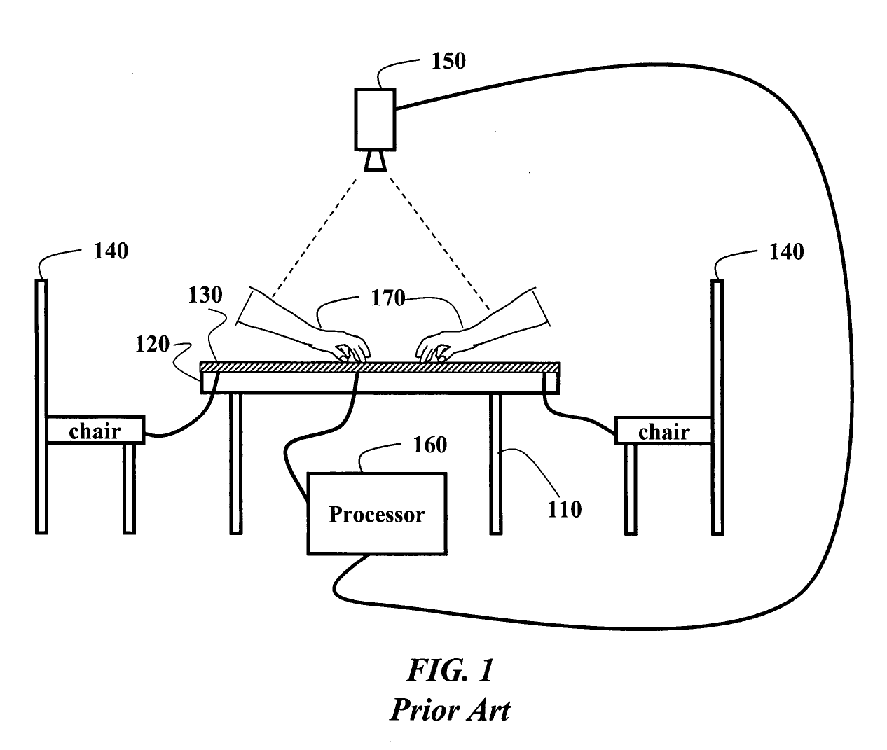

### DETAILED DESCRIPTION OF THE PREFERRED EMBODIMENT

Inverted Touchtable

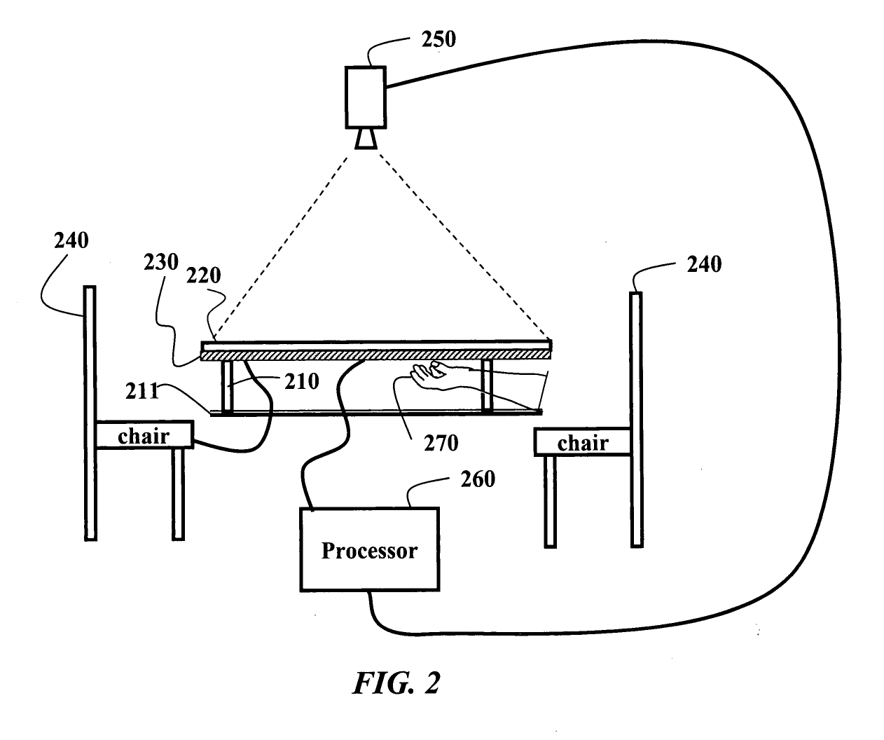

FIG. 2 shows a direct touch-sensitive display system according to an embodiment of our invention. Our system includes a table 210 with a display surface 220, a touch sensitive surface 230 is mounted on the back of the display surface, one or more chairs 240, a projector 250, and a processor 260. For convenience, the table 210 is placed on a secondary support surface 211.

As used herein throughout, “front” means on a side facing the user(s), and “back” means the opposite side facing away from the user(s). For a tabletop device these correspond to “top” and “bottom”.

The touch sensitive surface 230 geometrically coincides with the display surface 220. That is, locations on the touch sensitive surface have a one-to-one correspondence with positions on the display surface, making this a direct touch input device.

In order to maintain the sense of direct-touch input for a user while touching the back of the table, the thickness of the table front is minimized. For example, a distance between the front to the back is about 1 cm, so that an actual point of touch is as close to the displayed target as possible. It should be noted, that this thickness is significantly less than most conventional touch sensitive display surfaces. In one embodiment of our invention the antenna arrays of the DiamondTouch sensor are mounted on opposition sides of a thin sheet of opaque Lucite plastic. The sensors are coupled to a single controller to ensure synchronized timing of input data.

When a user sitting in one of the chairs 240 touches 270 the surface 230 a capacitive coupling is induced between the surface and the user. As a unique feature, multiple touches or gestures can be detected concurrently for a single user or multiple users because the chairs are individually coupled to the touch sensitive surface.

During operation, images are displayed on the surface 220 by the projector 250. The processor coordinates and controls the displayed images according to the touching. As a unique feature of our invention, the touching 270 in this case does not occlude the displayed images.

Two-Sided Touchtable

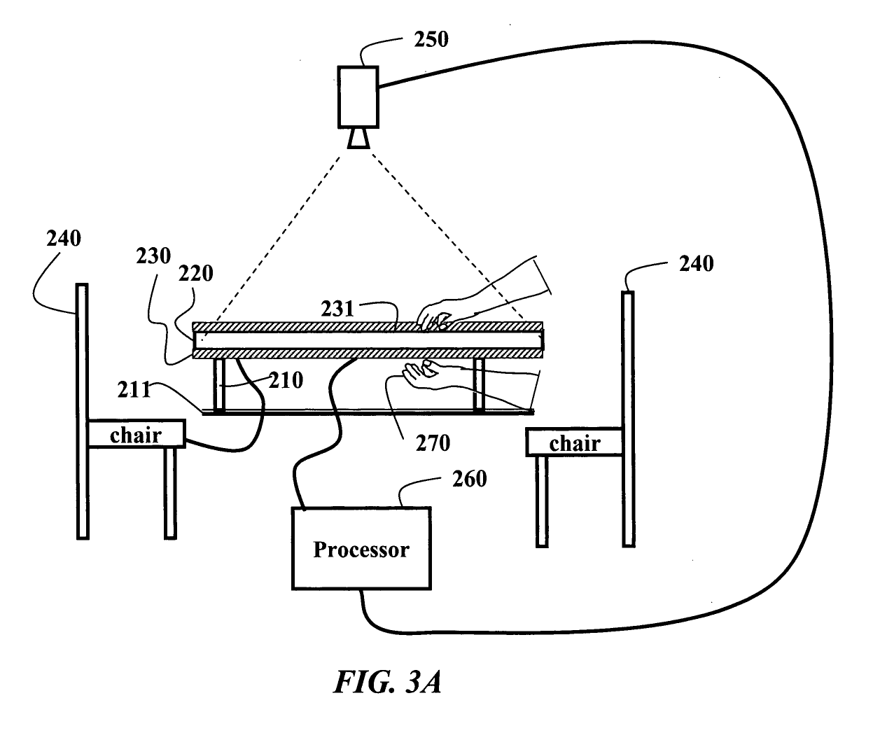

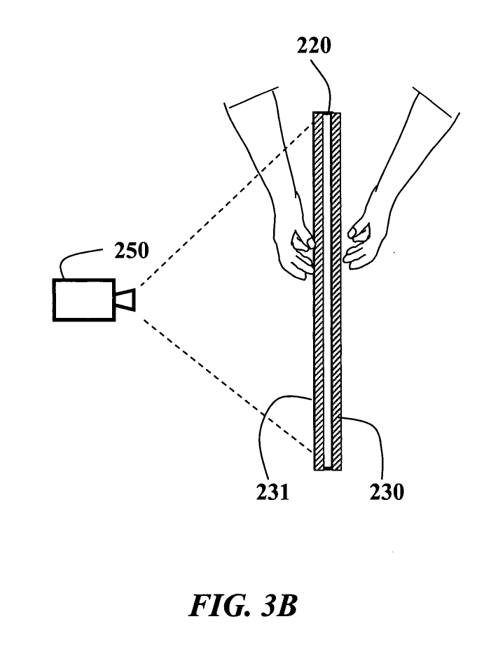

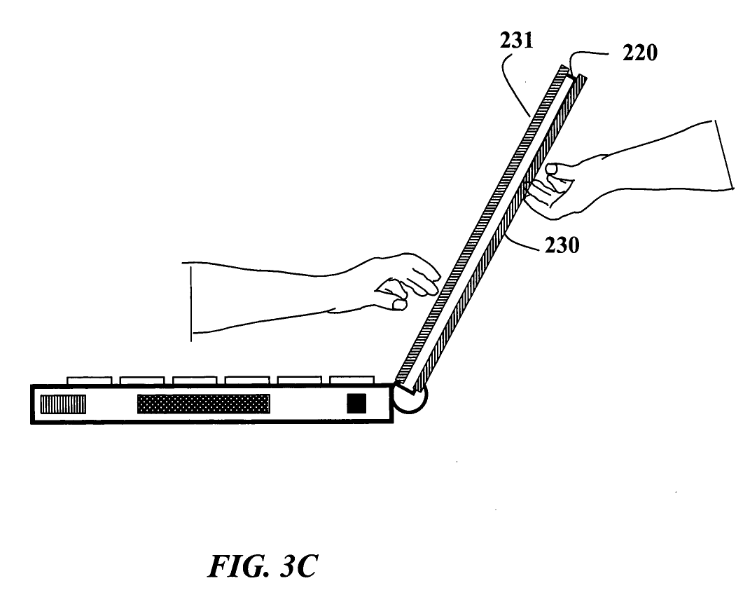

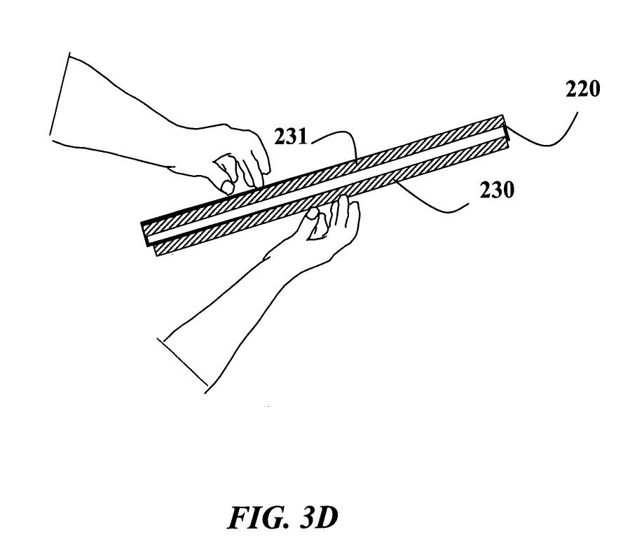

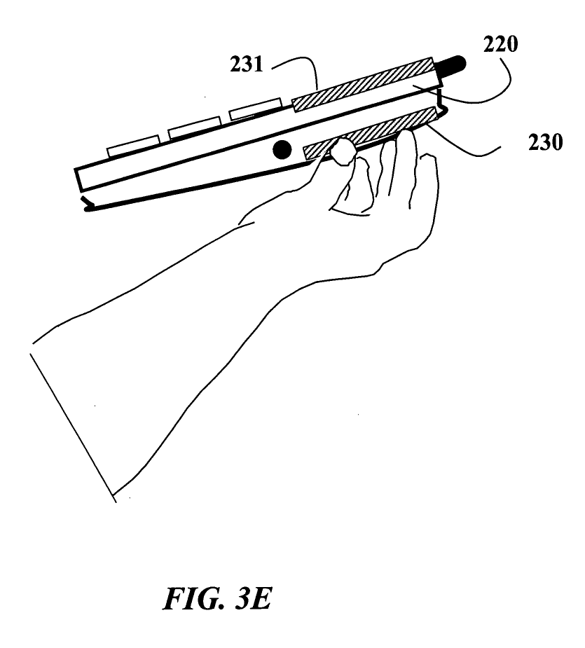

FIG. 3A shows an alternative embodiment where a second touch surface 231 is embedded in the front of the table 210. As above, the second touch surface 231 geometrically coincides with the display surface 220, as well as with the touch surface 230. In this version, users can touch either the front or the back of the display surface. The two coinciding touch surfaces are calibrated with each other, and with the displayed images. It should be noted that all surfaces are substantially parallel to each other, and aligned along a direction perpendicular to the surfaces. The inverted touchtable has a touch-sensitive surface mounted on the back side of a tabletop. The touch-sensitive surface is calibrated and registered with the front side display surface. The distinguishing characteristic of an inverted touchtable is that at least one the input area is on the back of the table, while the display remains on the front of the table.

FIG. 3B shows a top view of an alternative embodiment, where the display surface is arranged vertically on, for example, a stand. The user stands on a side of the display surface 220, while images are project on the front. As an advantage, the user can manipulate the display without obstructing the view to an audience in the front of the display. It should be understood that this configuration can also be one sided as in FIG. 2.

FIG. 3C shows a side view of an alternative embodiment of our invention. Here, the touch sensitive surfaces 230-231 are mounted on the front and back of a ‘lid’ of a laptop computer. The laptop can be configured with a LCD or plasma display. It should be understood that this configuration can also be one sided as in FIG. 2.

FIG. 3D shows a side view of an alternative embodiment of our invention. Here, the touch sensitive surfaces 230-231 are mounted on the front and back of a handheld computer device, such as a tablet PC, or a ‘palm’ top. It should be understood that this configuration can also be one sided as in FIG. 2.

FIG. 3E shows a side view of an alternative embodiment of our invention. In this case, the touch sensitive surfaces are mounted on the front and back of communications device, such as a mobile telephone. As before, the touch sensitive surface geometrically coincides with the display portion 220 of the device. It should be understood that this configuration can also be one sided as in FIG. 2.

It should also be noted, that the touch sensitive surface on the front of the device, that is the side facing the user, can also be an indirect touch surface such as a touchpad. Thus, touching either touch sensitive surfaces still does not occlude the display.

The two-sided direct touch input devices according to the embodiments of our invention provides a number of novel and interesting properties. Although the touch and display surfaces are separated, by ensuring exact registration between the geometrically coincident input surfaces and the display surface, an inverted touchtable is able to maintain many properties of a conventional direct-touch interface.

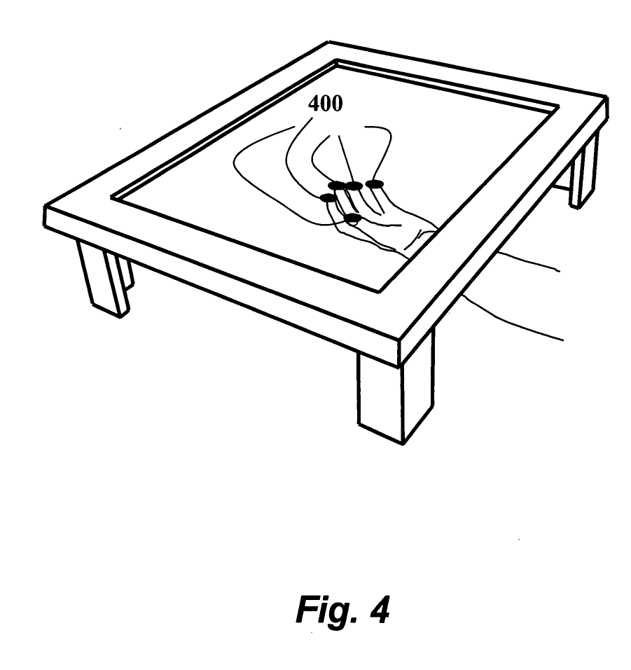

FIG. 4 shows multiple touch points 400 on the back of the table corresponding with visual elements on the front.

When interacting with a direct touch-sensitive display device that only have a touch sensitive surface on the front, occlusion of the display surface is unavoidable. Pointing at a displayed image requires the user to put a hand between the display surface and the eyes. By having a touch-sensitive surface on the back of the display surface, we eliminate this occlusion. This is desirable both for users working with intricate data and groups where one user may wish to observe displayed imagery currently under manipulation by another user.

With traditional tabletop interfaces, touching using a finger is difficult to do with a high degree of precision. Although systems typically enable pixel-level interaction, the precise pixel being targeted by a touch is hard for the user to determine or control, because multiple pixels are typically within the bounds of the touch area. It is impossible to offer in-place feedback to the user during the touch, because the selection point is generally occluded by the hand or at least a finger until it is removed.

Touch Strategies

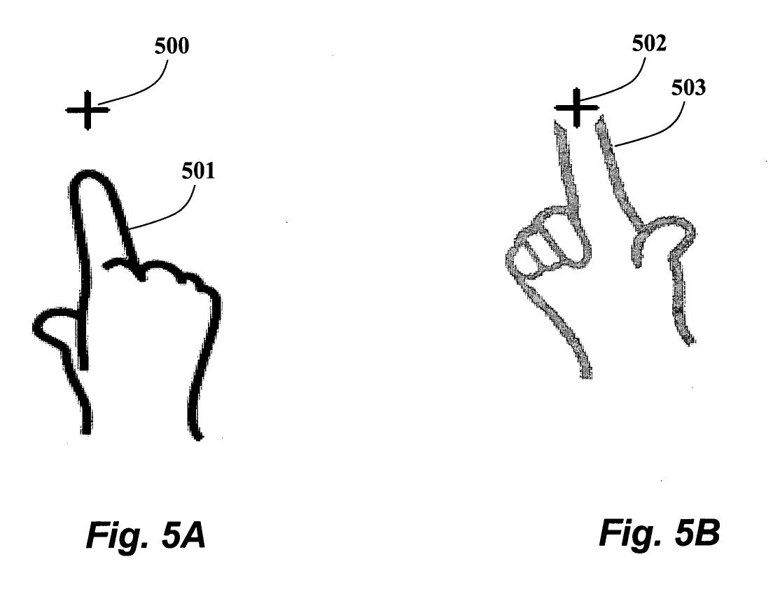

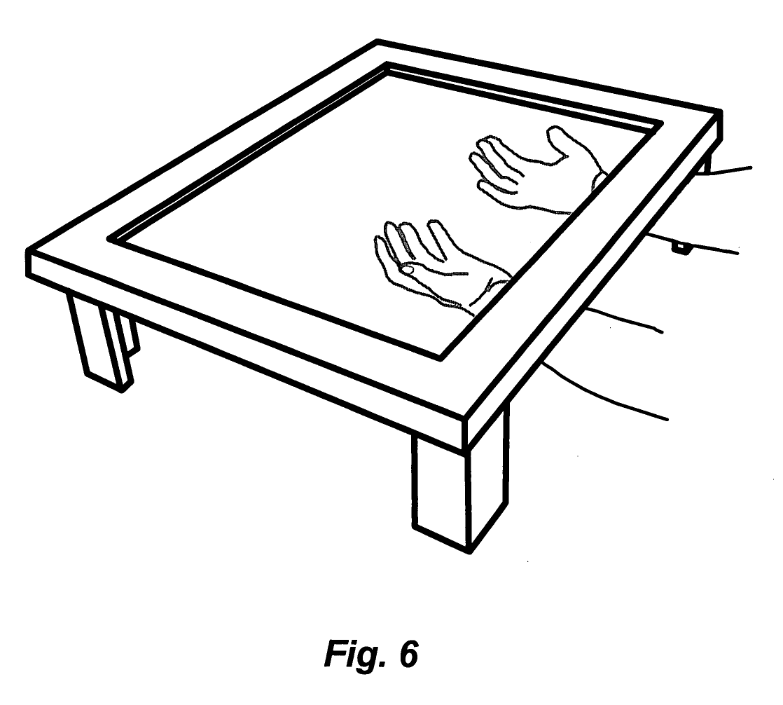

Three strategies have been described for touch interaction, land-on, first-contact, and take-off, Potter, R. L., Weldon, L. J., and Shneiderman, B., “Improving the accuracy of touch screens: an experimental evaluation of three strategies,” In Proceedings of the SIGCHI Conference on Human Factors in Computing Systems, ACM/CHI '88. ACM Press, pp. 27-32, 1988. A land-on strategy selects the object immediately below the finger at the initial point of contact. First-contact selection selects the first-on screen object the user's finger touches as the finger is “dragged” around the screen following the initial contact. The take-off selection is done by selecting the object that was last touched before the finger was removed from the screen. The take-off strategy varies from the others in that its target of influence is not the point of contact of the finger on the display, but rather a cross-hair 500 displayed approximately 0.5 inches above the finger 501 as shown in FIG. 5A.

The inverted touchtable allows for a take-off strategy to be employed, including visualisation of the point of influence 502, while maintaining a direct-touch input paradigm, as shown in FIG. 5B. The visualize point of influence 502 is positioned directly over the finger 503 which is below the display. By enabling the take-off strategy, we believe that pixel-level selection is actually superior using an inverted table, because, unlike on a regular table, the direct-touch input paradigm is maintained for take-off.

Privacy of Input

On a shared direct-touch system, all three stages of input are public—the input target specification, the input action, and the consequential change to the system, are all visible to all users. This can be advantageous in circumstances where knowledge of other users' actions is desirable, such as when performing collaborative tasks.

In some circumstances, however, this may not be desirable: users may wish to “hide” one of the targets of the input, the input action, or the system's induced output.

The issue of providing private output on a shared display is described by Shoemaker et al., “Single display privacyware: augmenting public displays with private information,” In Proceedings of the SIGCHI Conference on Human Factors in Computing Systems, ACM/CHI '01, pp. 522-529, 2001, and Yerazunis et al., “Privacy-Enhanced Displays by Time-Masking Images,” 2001, and for touchtables in particular by Matsushita et al. above, and Wu et al., “Multi-finger and whole hand gestural interaction techniques for multi-user tabletop displays,” In Proceedings of the 16th Annual ACM Symposium on User interface Software and Technology, ACM/UIST '03, pp. 193-202, 2003, all incorporated herein by reference.

However, none of these techniques enable private input with a shared direct-touch input interface. With an inverted touchtable, both the input gesture and its graphical target can be kept private from other users. Because display surface occludes the back input surface from view, users are able to specify a point of input known only to them.

Without visual feedback, users are generally able to select within a few centimetres of a target while pointing under the table, so actual visual feedback of the touched location is necessary only to complete and confirm selections, or for fine-grained interactions.

Accidental Touches Less Likely

Users of shared touchtables often make pointing gestures to graphical objects while discussing the objects. This causes accidentally input to the system. This is less likely when the display surface and input surface are not the same, because pointing on the display for reference does not provide input.

Arm Fatigue

A disadvantage of large direct-touch display surfaces is the need to make elaborate arm movements, increasing fatigue. This might be especially problematic for interaction on the back of a table, because the table's support structure is not available to serve as an arm rest. To reduce problem, one embodiment of the invention provides a support arm rest surface 211.

Change in Bimanual Posture

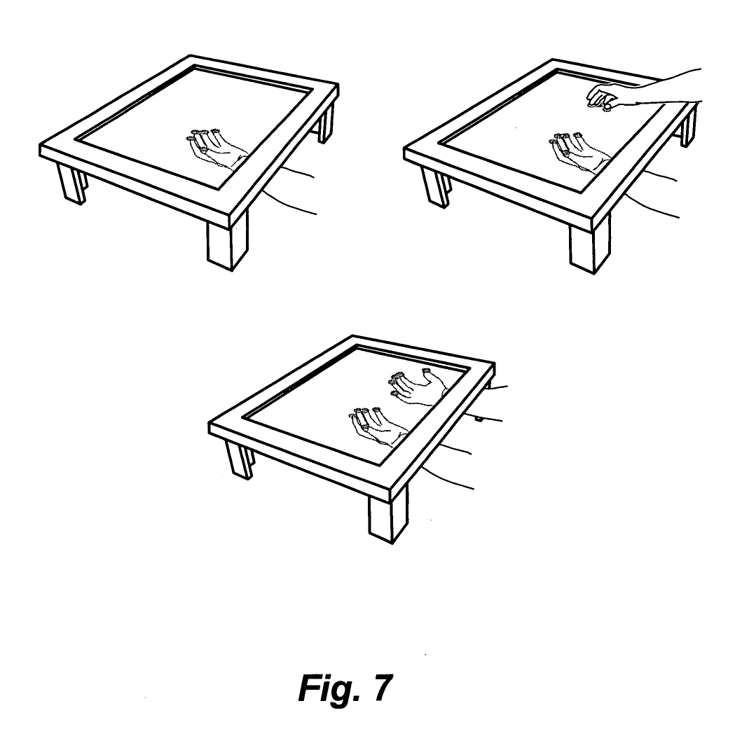

With conventional touchtables, bimanual interaction is typically done with the hands flat on the table, thumbs pointing towards one another. Bimanual input to an inverted touchtable mirrors this, so that the thumbs face away from one another, as shown in FIG. 6. This may have implications for designers of bimanual interaction. In particular, when not facing one another it may be that the hands are less prone to involuntary complementary movement, increasing the ease of asynchronous bimanual input.

Properties of a Two-Surface Touchtable

The addition of a second input area for direct-touch interaction offers several compelling advantages for the development of interactive systems. Our focus here is on interactions that would otherwise not be possible without a one-sided input surface.

More Input Bandwidth

The second touch surface effectively doubles the bandwidth of the input device. This doubling enables richer interaction and an overall larger control space for one, or multiple users.

Number and Table-Side of Hands has Meaning

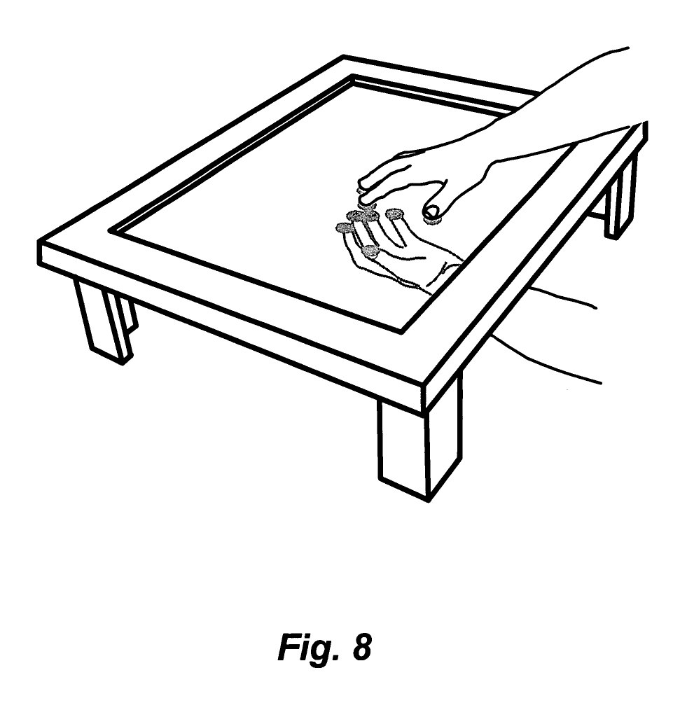

The side touched and number of hands being used for interaction is of importance for interaction, see FIG. 7. Input to the front and back can have identical, similar, or completely disparate effects. Additionally, the number and location of the hands has significance: a single hand above can have different semantic significance than a single hand below. Two hands above, two below, or one above and one below all afford potential significances in the semantics of interaction.

Sides Afford Modal Coupling

A two sided input can distinguish a dominant and non-dominant hand. This enables two modes to be maintained continuously, and can reduce errors with a moded interface. For example, the right hand can be considered dominant.

Co-Locality of Bimanual Interaction

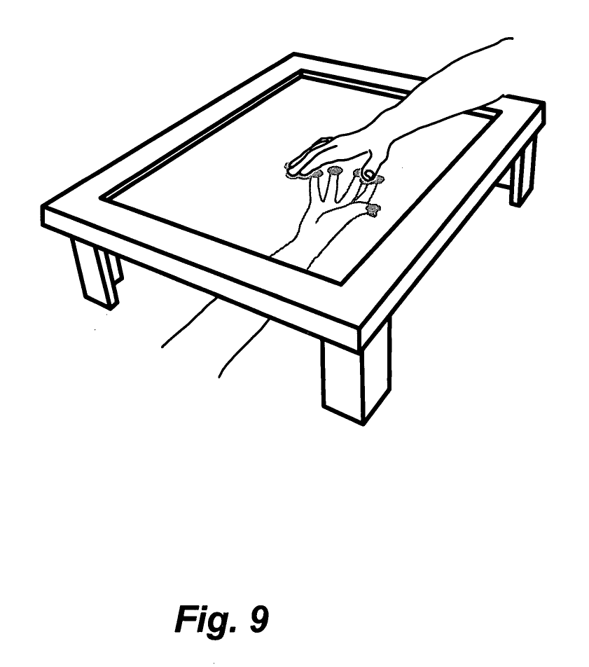

For our purposes, we define co-locality as whether or not the hands are operating within the same physical space with respect to the virtual space of the displayed images. When working within a direct-touch input table, co-locality of the virtual hands necessitates co-locality of the physical hands. Thus, some forms of bimanual input are not possible, because the hands cannot occupy the same space at the same time. A two-sided touchtable allows for both hands to effectively target the same physical location simultaneously, in a way that is not possible without causing physical interference on a regular one-sided touchtable. In the case of our two-sided tabletop, co-locality is enabled by one hand operating above, and the other below the surface of the table, as shown in FIG. 8.

Co-Locality of Interaction for Multiple Users

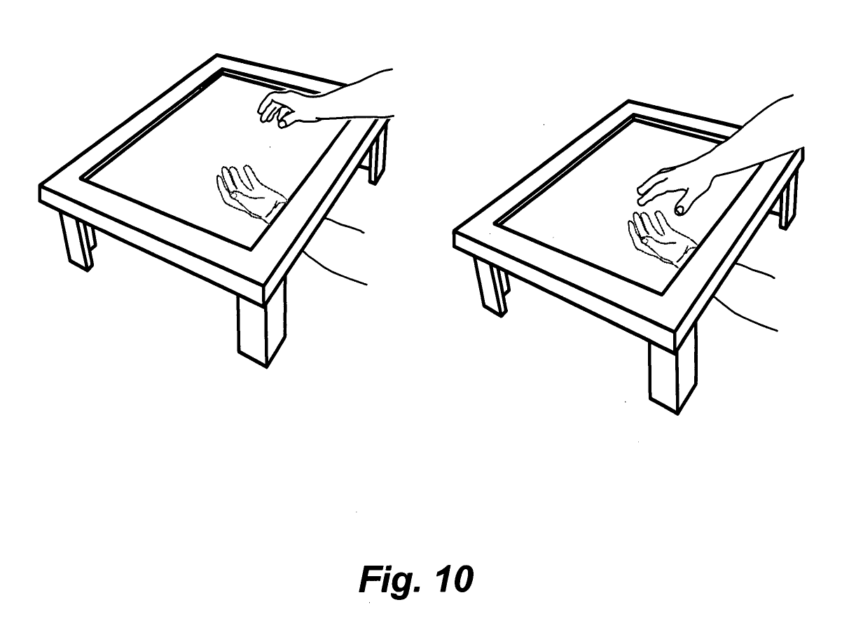

Not only does a two-sided touchtable enable co-locality for two hands of a single user, but it also enables co-locality of touch for multiple users. As shown in FIG. 9, positioning hands on opposite surfaces of the table allows two users to occupy the same virtual space at the same time. This is not possible with a single sided touchtable.

New Type of Symmetry in Bimanual Interaction

Traditional touchtable interfaces, where both hands are oriented with the palms down, afford a certain kind of symmetry of bimanual interaction. A two-sided touchtable affords two new types of bimanual symmetry, see FIG. 10. The first is oppositional translational symmetry, where the hands face one another and move in step. As well as rotational symmetry, where the hands are placed atop one another and rotated in opposition. Each of these types of bimanual symmetry affords a different type of interaction.

Potential for Reduction of Physical Interference

Two types of physical interference can occur on a direct-touch interface. The first, described above, occurs when two users wish to interact in the same physical space. The other occurs when one or more user attempts to place their hands in such a way that would otherwise cause the arms to pass over one another, or actually collide. A two-sided device allows bimanual interaction without this type of interference.

Three-Dimensional Input

For designers, a conventional touchtable provides a flat interaction and display area, similar to a desktop computer's display. A two-sided touchtable, however, presents a natural mapping of a third dimension, i.e., depth, to the application, where touches on the back of the table map to the ‘back’ of the volume, and likewise for touches on the front surface.

Alternate Input

One use for indirect touch on the back of the touchtable is for input to virtual spaces other than the one being projected onto the front of the table. In order to maintain a direct-touch input paradigm, each of these techniques would require a visual representation of some kind on the surface of the table. In particular, a miniature version of the ancillary display is rendered on the table.

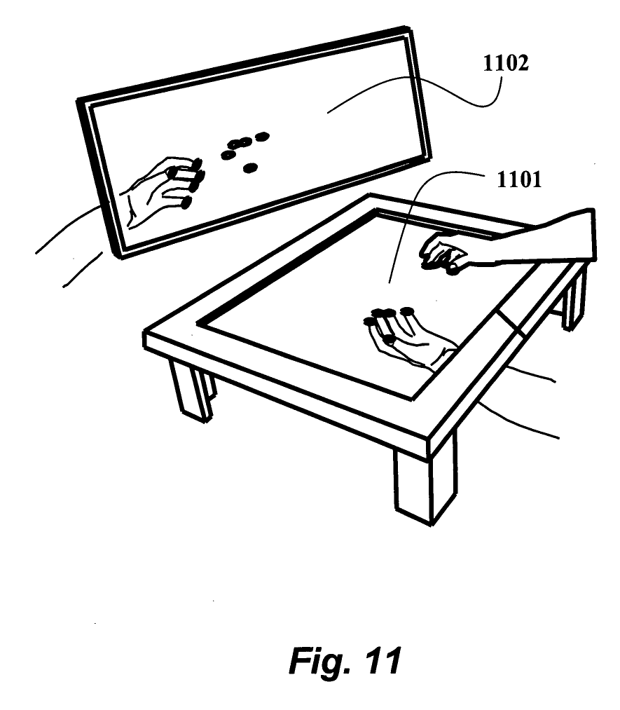

In application as shown in FIG. 11, the hand operating under the table has its events passed to an ancillary vertical display. Objects can be moved between the table 1101 and vertical display 1102 by dragging them to the position of the other hand, and ‘dropping’ them onto the other display. Note, the vertical display can also be manipulated from the back.

In addition to this literal mapping of physical spaces, it is also possible to map input to the back surface of the table to other virtual paradigms such as aural spaces.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A direct touch-sensitive input device, comprising:
a display surface configured to display images on a front of the display surface; and
a first direct touch-sensitive surface mounted on a back of the display surface, in which the display surface and the direct touch surface are geometrically coincident.

2. The device of claim 1, further comprising:
means for displaying the images on the front of the display surface; and
means, coupled to the first direct touch-sensitive surface, for controlling the images display according to touches on the direct touch-sensitive surface.

3. The device of claim 2, in which the means for displaying is a projector.

4. The device of claim 2, in which the means for displaying is a plasma display unit.

5. The device of claim 2, in which the means for displaying is a liquid crystal display.

6. The device of claim 1, in which the display surface and the first direct touch-sensitive surfaces are mounted horizontally.

7. The device of claim 1, in which the display surface and the first direct touch-sensitive surface are mounted vertically.

8. The device of claim 1, in which the display surface is a tabletop, and the first direct touch-sensitive surface is mounted on a back of the tabletop.

9. The device of claim 1, in which the display surface and the first direct touch-sensitive surface are parallel to each other and there is a one-to-one correspondence between locations on the first direct touch-sensitive surface and positions on the display surface.

10. The device of claim 1, in which multiple concurrent touches by multiple users are uniquely identified with the multiple users.

11. The device of claim 1, further comprising:
a second direct touch-sensitive surface mounted on the front of the display surface.

12. The device of claim 1, in which the first direct touch-sensitive surface is mounted on a back of a lid of a laptop computer.

13. The device of claim 1, in which the first direct touch-sensitive surface is mounted on a back of a handheld computer.

14. The device of claim 1, in which the first direct touch-sensitive surface is mounted on a back of a mobile telephone.

15. The device of claim 11, in which the first direct touch-sensitive surface, the second direct touch-sensitive surface and the display surface are calibrated with each other.

16. The device of claim 1, in which a distance between the front and the back of the direct touch-sensitive input device is about one centimeter.

17. The device of claim 1, in which orientations of hands touching the direct touch-sensitive surface are semantically distinguished.

18. The device of claim 11, in which a dominance of hands touching the first direct touch sensitive surface and the second direct touch-sensitive surface is distinguished.

19. The device of claim 11, in which oppositional translational symmetry, and rotational symmetry of hands touching the first direct touch-sensitive surface and the second direct touch-sensitive surface are distinguished.

20. The device of claim 11, in which the second direct touch-sensitive surface is geometrically coincident with the first direct touch-sensitive surface and the display surface.

21. The device of claim 11, in which the second touch-surface is an indirect touch surface.

22. A method for data input and data output, comprising the steps of:
displaying images on a front of a display surface; and
touching a direct-touch sensitive surface mounted on a back of the display surface to control the displaying of the images, in which the direct touch surface and the display surface are geometrically coincident.

23. The method of claim 22, in which the displaying comprises front projection.

24. The method of claim 22, in which the display surface and the direct touch-sensitive surface are parallel to each other and there is a one-to-one correspondence between locations on the direct touch-sensitive surface and positions on the display surface.

25. The method of claim 22, in which multiple concurrent touches by multiple users are uniquely identified with the multiple users.

26. The method of claim 22, further comprising:
providing an other touch-sensitive surface mounted on the front of the display surface; and
touching the other touch-sensitive surface.

27. The method of claim 22, further comprising:
calibrating the direct touch-sensitive surfaces and the display surface with each other.

28. The method of claim 22, in which orientations of hands touching the direct touch-sensitive surface are semantically distinguished.
